(19) United States
(12) Patent Application Publication
(10) Pub. No.: US 2017/0092012 A1
(43) Pub. Date: Mar. 30, 2017

(54) SPECIFICATION-BASED METHOD FOR GENERATING VIEWS IN 3D REPORTS

(71) Applicant: Siemens Aktiengesellschaft, Munchen (DE)

(72) Inventors: Sridharan Palanivelu, Monmouth Jct., NJ (US); Amit Chakraborty, East Windsor, NJ (US)

(21) Appl. No.: 14/870,412

(22) Filed: Sep. 30, 2015

(51) Int. Cl. G06T 19/20; G06T 13/20; G06T 15/30; G06F 17/22; G06F 17/27; G06F 17/21; G06T 11/00; G06F 17/24

(52) U.S. Cl. CPC G06T 19/20; G06T 11/001; G06T 13/20; G06F 17/248; G06F 17/2229; G06F 17/2705; G06F 17/211; G06T 15/30; G06T 2219/008; G06T 2219/2012

(57) ABSTRACT

A system and method for augmenting an existing u3d file to include additional 3D functions/illustrations accessible by anyone who later accesses the file is based upon adding a “composer” to the system used to generate 3D PDF reports. The composer utilizes a high-level specification based on a new “Additional Data Inclusion” (ADI) file format that defines additional types of 3D information that can be added to the existing u3d file. The various types of additional information may include, for example, additional viewing planes, clipping planes, textures, and the like. With the ability to add this type of information, an individual preparing a report including a 3D object is able to augment the supplied 3D information (i.e., the “existing” u3d file) with particular information that may be relevant to those individuals later reviewing the report.

### BACKGROUND

1. Technical Field

Aspects of the present invention relate to the generation of reports including three-dimensional (3D) objects and a method for incorporating additional 3D views to an existing 3D object during report generation, creating an augmented universal 3D (u3d) file to be imported into a report.

2. Description of Related Art

There are many industries and services that rely on the generation of three-dimensional (3D) images (objects) to transmit information. For example, many medical images are three-dimensional, and need to be transmitted from the person creating the image (e.g., radiologist) to a physician. Similarly, an engineer working on a component at a worksite location may need to transmit a three-dimensional image of the component to co-workers at another location.

In many situations, these 3D objects are included in a portable document format (PDF) document that is transmitted to other personnel for their use. The individual creating the PDF document is limited in the amount of information that may be associated with any 3D object. In many situations, it would be desirable to allow the document creator to embellish or modify the 3D model to highly those areas of the model that need attention by the readers of the document. For example, a radiologist sending a 3D image to an attending physician may want to add a different texture to a portion of the image, or modify the view of a particular portion of the model.

Heretofore, the personnel creating the report were unable to modify or embellish any of the information related to the embedded 3D objects. This is considered to be a severe limitation to the usefulness of including 3D objects in reports that are shared among a group of recipients.

### SUMMARY

The needs in the prior art are addressed by aspects of the present invention, which relate to a method for incorporating additional three-dimensional (3D) views to an existing 3D object during report generation.

In accordance with aspects of the present invention, a declarative specification method is used to include additional 3D editing and manipulation information within the actual universal 3D (u3d) file being imported into the report, creating an augmented u3d file. Defined as a new ADI (Additional Data Inclusion) format, the methodology in accordance with aspects of the present invention allows for additional views, cutting planes, texture planes and the like to be added to the description of a given 3D object, providing additional information to the report reader.

The inventive technique functions by parsing the u3d file that is to be imported into a report, and then parsing the available ADIs to create a set of additional descriptors relevant for that particular 3D object.

In one embodiment, aspects of the present invention take the form of a system that augments an existing u3d file to include additional information associated with a 3D object defined by the existing u3d file, where the system comprises a file source that defines an Additional Data Inclusion (ADI) file format, an ADI parser coupled to the file source, the ADI parser including high-level specification programs defining additional illustration data to be included in the description of the 3D object, and an ADI converter that transforms the ADI specifications created by the ADI parser into u3d format and incorporating the transformed ADI specifications into the existing u3d file to create an augmented u3d file.

Another embodiment can be defined as a system for generating a portable document format (PDF) document report including at least one active 3D object. In this embodiment, the system includes an input template including a plurality of template fragments to be used by a report creator in developing a specific report format, a template parser coupled to the input template and accessible by the report creator to configure selected template fragments into the specific report format, including instructions to import identified u3d files into the generated report, a source of active 3D objects, a data converter that translates information defining a selected 3D object into the u3d file format, a PDF report generator responsive to the specific report form and imported u3d files to generate a 3D PDF output report and a composer, accessible by the report creator, that augments information in at least one of the identified u3d files prior to importing the u3d file to the PDF report generator.

Additionally, aspects of the present invention are embodied as a method for augmenting an existing u3d file to include additional data in an Additional Data Inclusion (ADI) file format, the method comprising: (1) providing a file source that defines an Additional Data Inclusion (ADI) file format; (2) selecting, from the file source, additional information to be used to augment an existing u3d file; (3) creating a high-level ADI specification including a set of program steps defining additional illustration data to be included in the description of the 3D object; and (4) converting the high-level ADI specification into u3d format and incorporated the converted data into the existing u3d file to create an augmented u3d file.

Other and further aspects and embodiments of the present invention will become apparent during the course of the following discussion and by reference to the accompanying drawings.

### BRIEF DESCRIPTION OF THE DRAWINGS

Referring now to the drawings,

FIG. 1 is a block diagram of a system for generating additional views for three-dimensional (3D) objects included within portable document format (PDF) reports in accordance with aspects of the present invention;

FIG. 2 includes an exemplary Additional Data Inclusion (ADI) specification associated with defining an additional “view” to be included with an existing u3d file;

FIG. 3 includes an exemplary ADI specification associated with defining an additional clipping plane to be included with an existing u3d file;

FIG. 4 shows a set of meta-data to be stored with the 3D source information, required to create the additional clipping plane shown in FIG. 3;

FIG. 5 includes an exemplary ADI specification associated with defining an additional texture plane to be included with an existing u3d file;

FIG. 6 shows a set of meta-data to be stored with the 3D source information (including both scene meta-data and node meta-data) required to create the additional texture plane shown in FIG. 5;

FIG. 7 is an ADI specification associated with an exemplary arrangement for augmenting an existing u3d file by including two additional “views”;

FIG. 8 is an ADI specification associated with an exemplary arrangement for augmenting an existing u3d file by including three different “texture” planes; and

FIG. 9 is an ADI specification associated with an exemplary arrangement for augmenting an existing u3d file by including an additional “clipping” plane.

### DETAILED DESCRIPTION

There are currently a variety of different techniques for including three-dimensional (3D) objects within documents created in a higher-level language. Indeed, there are a number of systems available for incorporating 3D objects in portable document format (PDF) documents, where these systems allow for the “reader” of the document to manipulate the 3D object. In this regard, the disclosure of U.S. patent application Ser. No. 14/870,380, Attorney Docket Number 2014P26357US, which is incorporated herein by reference in its entirety and is assigned to Siemens, the assignee herein, describes a system and method for using an XML input template to import 3D objects in a manner where the recipient does not require vendor-specific software to activate the 3D capabilities of the object.

In general, PDF reports can have 3D objects, along with other active and passive objects. Also, as stated above, the 3D models can have views for the report reader to rotate and/or zoom into or out of the 3D object, so as to view the object from various angles or sides. However, there has been no way for the document creator to “edit”, so to speak, the 3D file to include other parameters that may be of interest.

In accordance with aspects of the present invention, it is now possible to include different 3D views to an existing 3D object. A 3D semantic view defines a particular cutting plane of a 3D object from a given camera angle. This cutting plane can be augmented with a given image and dynamic transparency settings that are aligned with the cutting plane. The semantic views are used to provide a better visualization of this augmented 3D information to readers of the generated report (such as doctors, CAD engineers, etc.) in many different scientific and engineering domains.

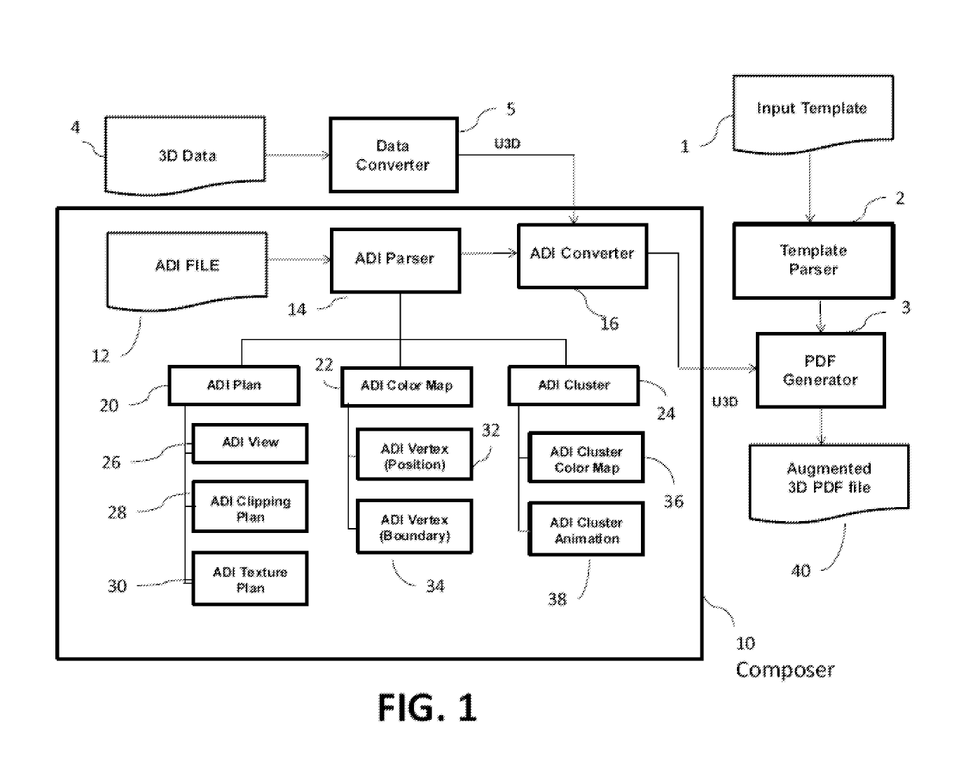

As shown in FIG. 1, a 3D PDF composer 10 is used in conjunction with known report generation tools to include the specified 3D semantic views to existing u3d files during report generation. The report generation tools shown in FIG. 1 are similar to those described in our co-pending application and include an input template 1 used to define a set of parameters for the report to be generated and a template parser 2 that is used by the report creator to select the various portions of the input template that are required for that specific report. Relevant data, including the identity of the specific universal 3D (u3d) files to be imported, is added to template parser 2 by the report creator.

An “interactive” PDF report generator 3 receives the input data from template parser 2 and then retrieves the 3D objects called for in the template from a 3D data source 4. As shown in FIG. 1, the actual 3D data is first passed through a data converter 5 to present the 3D data in the u3d file format used in most systems. PDF report generator 3 then provides as an output a 3D PDF file (that is, a PDF report including one or more embedded 3D objects).

In accordance with aspects of the present invention, this system is enhanced by including 3D PDF composer 10 which is able to include a high-level specification to describe view information, as well as clipping plans and texture planes, within the u3d file created by data converter 5.

As mentioned above, composer 10 is based upon the creation of a novel Additional Data Inclusion (ADI) format. As shown in FIG. 1, composer 10 includes three basic ADI modules, an ADI file source 12, an ADI parser 14 and an ADI converter 16. As will be described in detail below, ADI file source 12 includes the various program modules that may be used to implement one of more of the additional views/augmented information to be included with the 3D object. The individual creating the report accesses composer 10 and interacts with ADI file source 12 to determine the particular type(s) of additional information that is to be included.

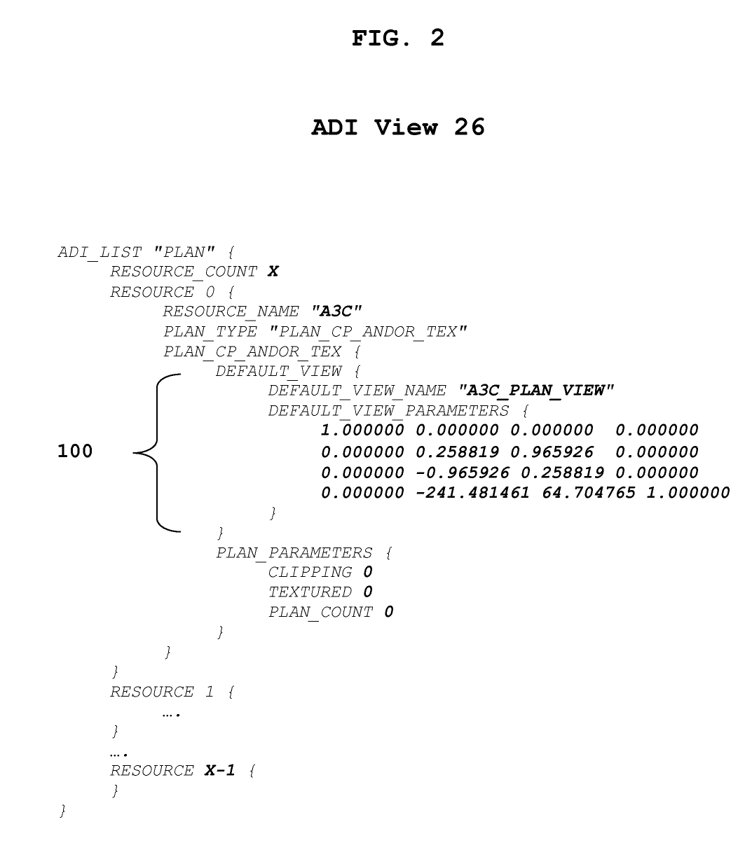

ADI parser 14 is used to develop the details of the specific types of additional information to be included. At a first level, parser 14 includes a set of three categories, shown as ADI Plan 20, ADI Color Map 22 and ADI Cluster 24. ADI Plan 20 itself includes three plan-related specific elements: ADI view 26, ADI clipping plane 28 and ADI texture plane 30. These elements will be discussed below in association with FIG. 2-4. ADI Color Map 22 includes two specific elements, a position vertex “color map” 32 (associated with the position of a specific portion of the 3D object) and a boundary vertex “color map” 34 (associated with the outline of a specific portion of the 3D object). Additionally, ADI cluster 24 includes two different editing elements, ADI cluster color map 36 and ADI cluster animation 38.

In accordance with aspects of the present invention, the individual creating the PDF report utilizes the tools within composer 10 to augment the original parameters associated with a 3D object to include additional views, cutting planes, textures, and the like to supply additional information to those individuals receiving the generated report. Once all of the desired additional information has been identified by the individual creating the PDF report, ADI converter 16 is used to convert this information into u3d file format, creating an “augmented u3d” file. The augmented u3d file is then sent to PDF report generator 3, which functions to create an augmented 3D PDF file 40 as the generated output report of the system.

FIGS. 2-7 include exemplary specification descriptions that allows for defining views within the u3d file being imported to a PDF report. In particular, FIG. 2 shows an exemplary high-level specification as used by ADI view element 26 for allowing additional views to be included in the u3d file. Segment 100 of the specification shown in FIG. 2 illustrates the specific statements defining a “view” for a first resource (defined as “Resource 0”) within the u3d file. Other resources may include similar segments (i.e., for Resources 1 through X−1).

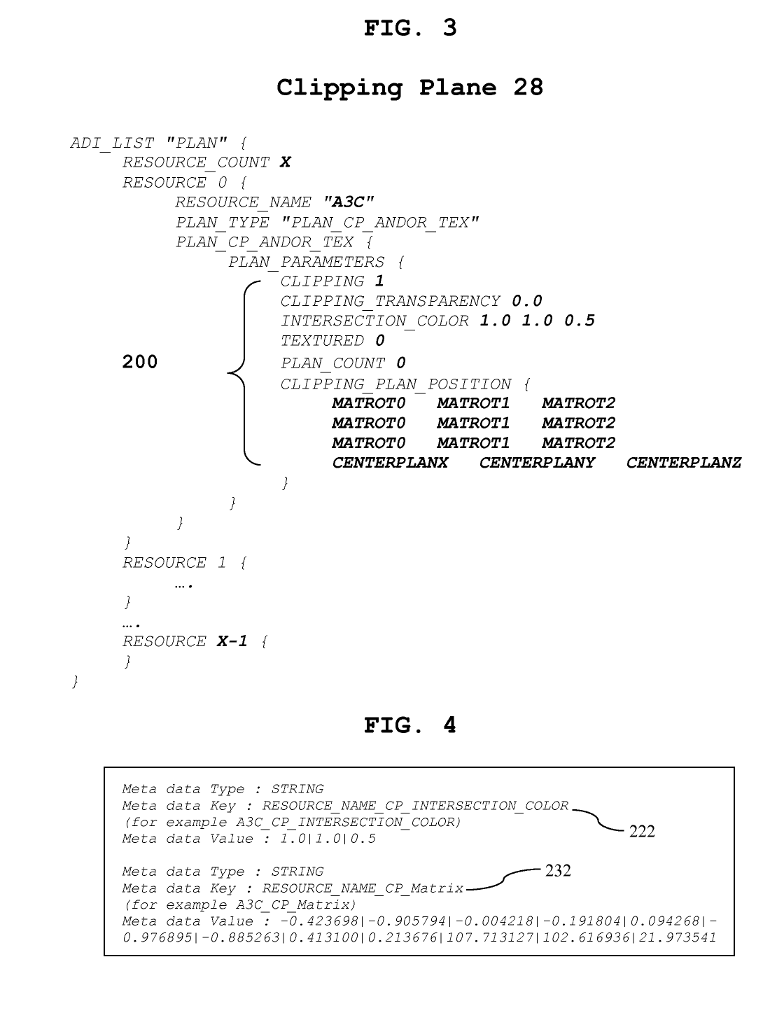

An exemplary specification that allows for defining additional clipping planes (via ADI Clipping Plane element 28) is shown in FIG. 3. Here, segment 200 is shown as identifying the specific details required to define a clipping plane to be added to a defined “resource” (here, “Resource 0”). As shown, attributes such as the clipping transparency 210, intersection color 220, and position 230 are defined within this segment.

Inasmuch as the conventional u3d file format does not have any properties for specifying clipping planes, the attributes associated with clipping plane 200 are stored as scene meta-data of the u3d file (within 3D data file 4). FIG. 4 illustrates one exemplary configuration for storing the clipping plan attributes as scene meta-data, here including a first key 222 associated with intersection color attribute 220 and a second key 232 (identified as “matrix”) associated with position attribute 230.

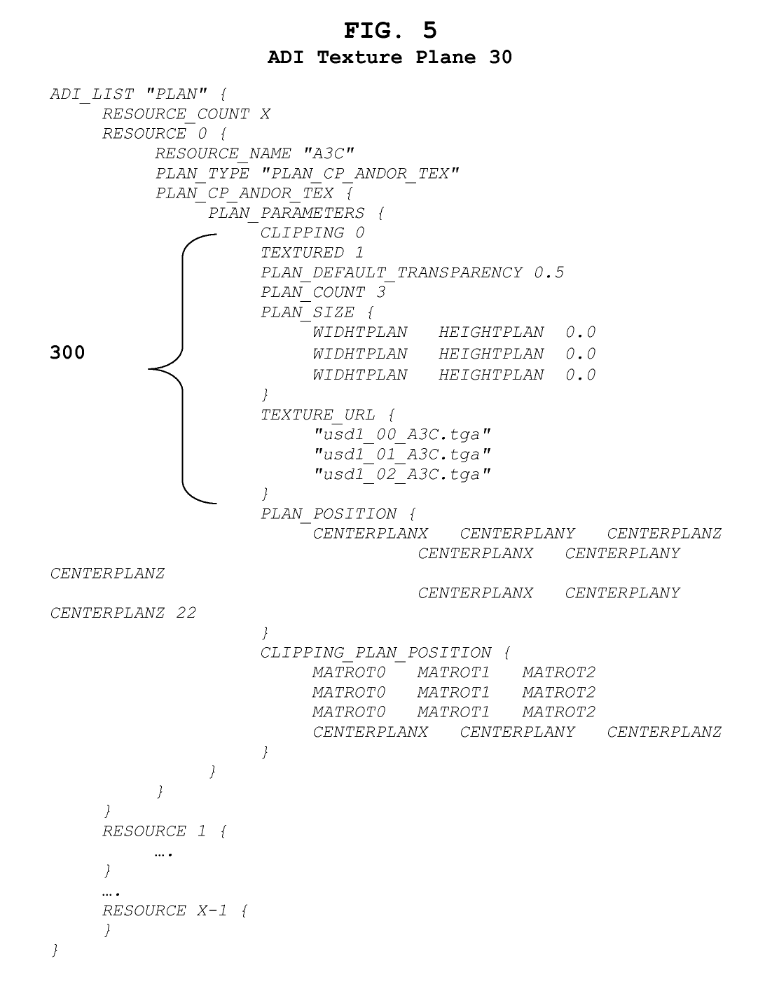

FIG. 5 illustrates an exemplary ADI specification associated with adding a texture plane to one or more portions of a 3D image as defined by a u3d file. Here, segment 300 illustrates the specific statements used to add a specific type of texture to a predefined plane (position) within the u3d file. Again, similar texture definitions may be included for other “resources” as defined by the ADI specification. Similar to the implementation of additional clipping planes, the attributes of the augmented texture (both for nodes as well as the scene) need to be stored as meta-data with the original 3D file.

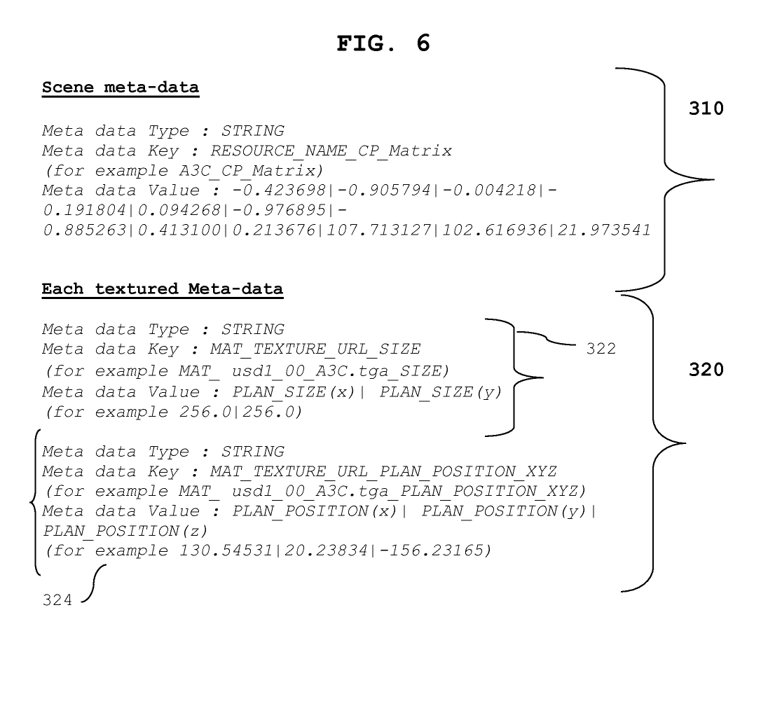

FIG. 6 illustrates an exemplary listing of meta-data associated with defining a texture plane. As shown, the listing in FIG. 6 includes a first segment 310 defining scene-specific meta-data and a second segment 320 defining node-specific meta-data. Second segment 320 is shown in this case as including meta-data for two different nodes, identified a first segment portion 322 and a second segment portion 324.

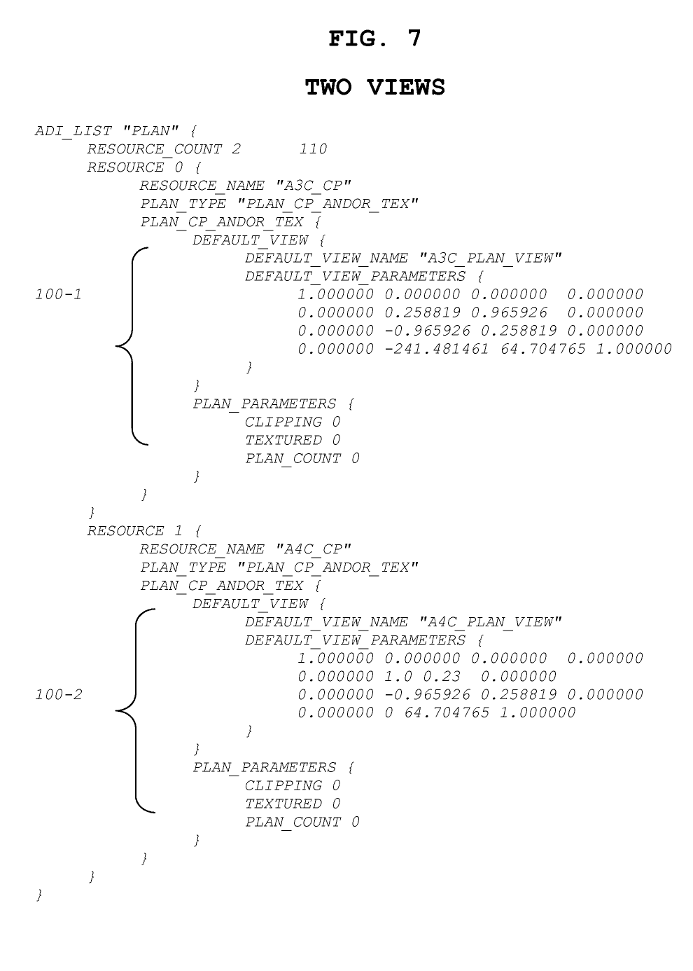

FIG. 7 shows an exemplary ADI specification for including two additional views to a 3D object as it is being incorporated in a PDF report. That is, in accordance with aspects of the present invention, a person creating the PDF invokes composer 10, and enters ADI view module 26. The report creator defines the need to add two additional views (shown as “resource_count 2” 110 in FIG. 7). Each additional view is then specified by its unique parameters, with the first view defined by specification segment 100-1 and the second view defined by specification segment 100-2.

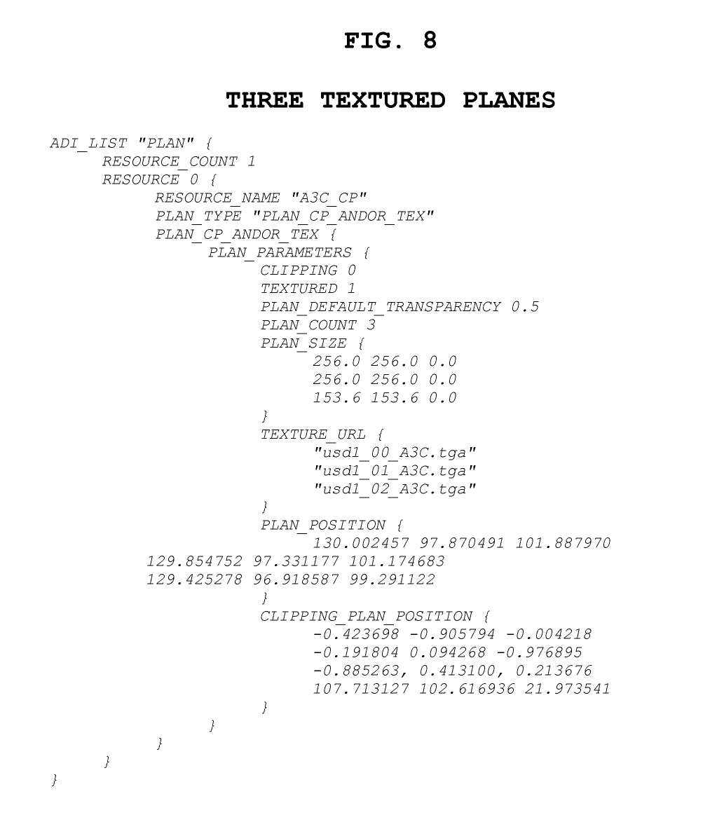

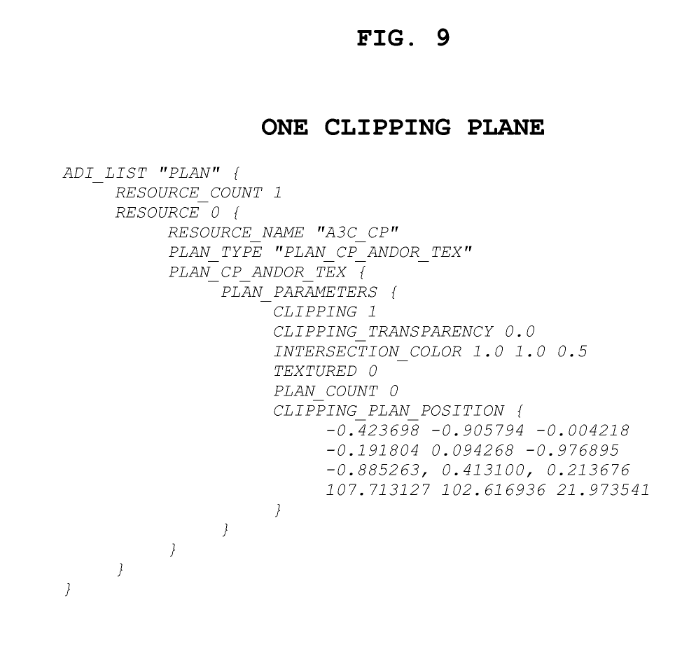

Presuming that this is the only information to be added to the existing 3D object, ADI parser 14 passes this ADI specification to ADI converter 16, which will then convert the data into u3d file format, and present the augmented file to PDF generator 3. Similar to FIG. 7, FIG. 8 shows an exemplary ADI specification for including three additional texture planes to a 3D object and FIG. 9 shows an exemplary ADI specification for including a clipping plane to a 3D object.

Summarizing, the utilization of a composer for “Additional Data Inclusion” (ADI)-formatted data to an existing u3d file allows for a person creating a report including the 3D object to augment the file with additional information (views, clipping planes, textures, etc.) that is desired to be passed on to the readers of the report. The inventive method specifies 3D semantic views, which define a particular cutting plane of a given 3D object from a given angle. This cutting plane is augmented with image information, where the transparency settings are aligned with the 3D object.

The inclusion specification method in accordance with aspects of the present invention is able to combine D graphics data with images, and is able to specify the augmented 3D models by real images. The method supports image transparency in augmented 3D models and, therefore, is able to provide “see-through” images (i.e., 100% transparency) automatically within internal 3D models, enabling previously hidden elements to become visible to the reader of the generated report.

Although illustrative embodiments of aspects of the present invention have been described herein with reference to the accompanying drawings, it is to be understood that the invention is not limited to those precise embodiments, and that various other changes and modifications may be effected therein by one skilled in the art without departing from the scope of spirit of aspects of the present invention.

What is claimed is:

1. A system that augments an existing universal 3D (u3d) file to include additional information associated with a three-dimensional (3D) object defined by the existing u3d file, the system comprising:
a file source that defines an additional data inclusion (ADI) file format;
an ADI parser coupled to the file source, the ADI parser including high-level specification programs defining additional illustration data to be included in the description of the 3D object; and
an ADI converter that transforms the ADI specifications created by the ADI parser into u3d format and incorporating the transformed ADI specifications into the existing u3d file to create an augmented u3d file.

2. The system according to claim 1 wherein the ADI parser further includes high-level specification programs defining additional planes to be included in the existing u3d file.

3. The system according to claim 2 wherein the additional planes include one or more additional view planes.

4. The system according to claim 2 wherein the additional planes include one or more additional clipping planes.

5. The system according to claim 2 wherein the additional planes include one or more additional texture planes.

6. The system according to claim 1 wherein the ADI parser further includes high-level specification programs defining color attributes to be added to the existing u3d file.

7. The system according to claim 6 wherein the defined color attributes include position colors.

8. The system according to claim 6 wherein the defined color attributes include boundary colors.

9. The system according to claim 1 wherein the ADI parser further includes high-level specification programs defining cluster attributes to be added to the existing u3d file.

10. The system according to claim 9 wherein the cluster attributes include a cluster color map.

11. The system according to claim 9 wherein the cluster attributes including cluster animation.

12. A system that generates a portable document format (PDF) document report including at least one active three-dimensional (3D) object, the system comprising:
an input template including a plurality of template fragments to be used by a report creator in developing a specific report format;
a template parser coupled to the input template and accessible by the report creator to configure selected template fragments into the specific report format, including instructions to import identified universal 3D (u3d) files into the generated report;
a source of active 3D objects;
a data converter that translates information defining a selected 3D object into the u3d file format;
a PDF report generator responsive to the specific report form and imported u3d files to generate a 3D PDF output report; and
a composer, accessible by the report creator, that augments information in at least one of the identified u3d files prior to importing the u3d file to the PDF report generator.

13. The system according to claim 12 wherein the composer comprises:
a file source that defines an additional data inclusion (ADI) file format;
an ADI parser coupled to the file source, the ADI parser including high-level specification programs defining additional illustration data to be included in the description of the 3D object; and
an ADI converter that transforms the ADI specifications created by the ADI parser into u3d format and incorporating the transformed ADI specifications into the existing u3d file to create an augmented u3d file to be sent to the PDF report generator.

14. The system according to claim 12 wherein the 3D data file includes a memory elements that stores meta-data associated with ADI specifications.

15. A method that augments an existing universal 3D (u3d) file to include additional data in an additional data inclusion (ADI) file format, the method comprising:
providing a file source that defines an ADI file format;
selecting, from the file source, additional information to be used to augment an existing universal u3d file;
creating a high-level ADI specification including a set of program steps defining additional illustration data to be included in the description of a three-dimensional (3D) object; and
converting the high-level ADI specification into u3d format and incorporated the converted data into the existing u3d file to create an augmented u3d file.

16. The method according to claim 15 wherein the existing u3d file is augmented to include at least one additional view.

17. The method according to claim 15 wherein the existing u3d file is augmented to include at least one clipping plane.

18. The method according to claim 15 wherein the existing u3d file is augmented to include at least one texture plane.

19. The method according to claim 15 wherein the existing u3d file is augmented to include additional color map information.

20. The method according to claim 15 wherein the existing u3d file is augmented to include additional cluster information.
